(19) United States
(12) Patent Application Publication
(10) Pub. No.: US 2005/0106427 A1
(43) Pub. Date: May 19, 2005

(54) DIRECT OPERATION OF LOW TEMPERATURE SOLID OXIDE FUEL CELLS USING OXYGENATED FUEL

(75) Inventors: Erica Murray, Waterford, MI (US); Stephen Harris, Bloomfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/707,037

(22) Filed: Nov. 17, 2003

(51) Int. Cl. H01M 8/12; H01M 4/90; H01M 8/04

(52) U.S. Cl. 429/13; 429/30; 429/45; 429/26

(57) ABSTRACT

The present invention provides a method of operating a solid oxide fuel cell having an anode and a cathode using a methyl ether. The method of this embodiment comprises forming a first mixture comprising molecular oxygen and the methyl ether. The first reaction mixture is then heated to a sufficient temperature to form a second mixture comprising carbon monoxide and molecular hydrogen. Finally, the anode of a solid oxide fuel cell is in contact with the second gaseous mixture. In another embodiment, the invention provides a fuel cell system that utilizes the methods of the invention.

### BACKGROUND OF INVENTION

1. Field of the Invention

In at least one embodiment, the present invention relates to methods of improving the performance of solid oxide fuel cells operated with dimethyl ether and to fuel cell systems utilizing dimethyl ether.

2. Background Art

Fuel cells are electrochemical devices that convert the chemical energy of a fuel into electricity and heat without fuel combustion. In the one type of fuel cell hydrogen gas and oxygen gas are electrochemically combined to produce electricity. The hydrogen used in this process may be obtained from natural gas or methanol while air provides the oxygen source. The only by products of this process are water vapor and heat. Accordingly, fuel cell-powered electric vehicles reduce emissions and the demand for conventional fossil fuels by eliminating the internal combustion engine (e.g., in completely electric vehicles) or operating the engine at only its most efficient/preferred operating points (e.g., in hybrid electric vehicles). However, while fuel cell-powered vehicles have reduced harmful vehicular emissions, they present other drawbacks.

PEM fuel cells comprise an anode and a cathode which are separated by a polymeric electrolyte or proton exchange membrane (“PEM”). Each of the two electrodes may be coated with a thin layer of platinum. At the anode, the hydrogen is catalytically broken down into electron and hydrogen ions. The electron provides the electricity as the hydrogen ion moves through the polymeric membrane towards the cathode. At the cathode, the hydrogen ions combine with oxygen from the air and electrons to form water.

Solid oxide fuel cells (“SOFCs”) are an alternative fuel cell design that is currently undergoing significant development. Direct oxidation of hydrocarbon fuels at solid oxide fuel cells is of particular interest for portable and vehicle applications, as it eliminates the need for a fuel reformer. Operating SOFCs by directly supplying fuel to the cell can reduce the size and requirements for the balance-of-plant. In addition, it is possible that lower system costs and greater system efficiency can be realized by operating via direct oxidation.

Recently, direct oxidation of hydrocarbons has been demonstrated using SOFCs operating at low-to-medium temperatures (500-800 C). SOFCs using anodes containing Ni—Y₂O₃ stabilized ZrO₂ and (Ce,Y)O₂ have achieved complete electrochemical oxidation of methane fuel. Maximum power densities for these cells ranged from 0.125 to 0.357 W/cm² when operated at 550 and 650 C, respectively. SOFCs operating directly on higher hydrocarbons, such as n-butane, toluene, and synthetic diesel fuels, have been successful using cells composed of Cu-ceria anodes. No carbon deposition was observed over several hours of operation, and the highest power density (0.22 W/cm² at 800 C) was achieved for n-butane. In these studies, and most others concerning direct oxidation, identifying anode materials that avoid carbon deposition while promoting rapid electrochemical oxidation has been the primary objective. Another approach toward achieving complete electrochemical oxidation at SOFCs is to consider fuels less likely to produce carbon and to study the performance of such fuels at anodes with rapid kinetics. For example, a study using alcohol fuels indicates that methanol and ethanol mixtures give relatively high power densities without generating carbon deposits.

Recently, dimethyl ether (“DME”, CH₃—O—CH₃) has been considered as a potential alternative to diesel fuel for compression ignition engines, as odor, NOₓ, and carbon-based emissions are reduced. Since DME is an oxygenated fuel and lacks C—C bonds, it is less prone to coking. Natural gas, coal, and methanol are abundant resources from which DME can be directly derived. DME has previously been considered for fuel-cell operation. In one study, steam reforming of DME was proposed for molten carbonate fuel cells (MCFCs). In comparison to methanol steam reforming, the data indicated that higher energy density, cell voltage, and electrical power density could be achieved at MCFCs operating with DME-reformed fuel. Direct oxidation of DME has been compared to direct methanol oxidation at polymer electrolyte membrane (PEM) fuel cells. Though power densities were comparable for cells operated directly using DME or methanol, fuel crossover was significantly reduced and the total efficiency was about 10-30% higher depending on current density for direct DME oxidation at 130° C. Although, DME works reasonably well as a fuel for SOFCs further improvement in efficiency are still needed.

Accordingly, there exists a need for methods of increasing the efficiency of solid oxide fuel cells, and in particular, for solid oxide fuel cells operated with dimethyl ether.

### SUMMARY OF INVENTION

The present invention overcomes the problems in the prior art by providing in one embodiment a method of operating a solid oxide fuel cell having an anode and a cathode using a methyl ether. The method of this embodiment comprises forming a first mixture comprising molecular oxygen and a compound having formula 1:
CH₃—O—R 1
wherein R is alkyl, aryl, alkaryl, or arakyl. The first reaction mixture is then heated to a sufficient temperature to form a second mixture comprising carbon monoxide and molecular hydrogen. Finally, the anode of a solid oxide fuel cell is in contact with the second gaseous mixture. The second mixture is the fuel that powers the solid oxide fuel cell.

In another embodiment of the present invention, a fuel cell system which utilizes the method of the invention is provided. The system of this embodiment comprises a source of a first mixture comprising molecular oxygen and a methyl ether, a heat source that heats the first mixture to a sufficient temperature to form a second mixture comprising carbon monoxide and molecular hydrogen, a solid oxide fuel cell having an anode and a cathode, and a conduit for contacting the anode of the solid oxide fuel cell with the second gaseous mixture.

### BRIEF DESCRIPTION OF DRAWINGS

FIG. 1 is a schematic of the apparatus used to measure the electrical properties of a solid oxide fuel cell operated by the method of the invention;

FIG. 2 provides plots of voltage vs. current density for a solid oxide fuel cell operating with pure DME and 33% DME in air at 550° C., 600° C., and 650° C.;

FIG. 3 provides plots of power density vs. current density for a solid oxide fuel cell operating with pure DME and 33% DME in air at 550° C., 600° C., and 650° C.; and

FIG. 4 provides plots of power density vs. current density for a solid oxide fuel cell operating with pure DME, 33% DME in air, and 33% DME in nitrogen at 550° C.

### DETAILED DESCRIPTION

Reference will now be made in detail to presently preferred compositions or embodiments and methods of the invention, which constitute the best modes of practicing the invention presently known to the inventors.

In an embodiment of the present invention, a method of operating a solid oxide fuel cell having an anode and a cathode is provided. The method of this embodiment comprises forming a first mixture comprising molecular oxygen and a compound having formula 1:
CH₃—O—R 1
wherein R is alkyl, aryl, alkaryl, or arakyl. More preferably, R is a C₁₋₆ alkyl; and most preferably, R is methyl. The first reaction mixture, is then heated to a sufficient temperature to form a second mixture comprising carbon monoxide and molecular hydrogen. Finally, the anode of a solid oxide fuel cell is in contact with the second gaseous mixture. The second mixture is the fuel that powers the solid oxide fuel cell. Preferably, the solid oxide fuel cell includes an anode comprising a nickel-containing cermet. Suitable nickel-containing cermets include for example, Nickel mixed with gadolina doped ceria (Ni—(Ce0.8Gd0.2O) also written as Ni—(Ce,Gd)O₂ or Ni-GDC, nickel mixed with yttria doped ceria zirconia (Ni—[Y₂O₃—(CeO₂)0.7(ZrO₂)0.3] also written as Ni-YDCZ), and nickel mixed with yttria doped zirconia (Ni—Y-stabilized ZrO also written as Ni-YSZ.) Although any source of molecular oxygen may be used including pure oxygen, the most economical and convenient source is air.

The method of the present invention advantageously allows the fuel cell to be operated at a temperature that is less than about 650° C. Moreover, the first mixture is efficiently converted to the second mixture by heating at a temperature at least about 450° C. More preferably, the first mixture is efficiently converted to the second mixture by heating at a temperature of at least about 550° C. Most preferably, the first mixture is efficiently converted to the second mixture by heating at a temperature from about 550° C. to about 650° C. The methods of the present invention advantageously utilize the reaction:
CH3-O—R+O₂->CO+H₂+other reaction products
where R is given above. When R is methyl, the other reaction products are mostly methane which is a desirable fuel. It has been observed that very little water and carbon dioxide are produced in this reaction particularly when R is methyl. Moreover, in order to reduce the amount of water and carbon dioxide production the molar ratio of molecular oxygen to a compound having formula 1 is from about 0.1 to about 3.0. More preferably, the molar ration of molecular oxygen to a compound having formula 1 is from about 0.1 to about 1.0.

In a particularly preferred embodiment of the present invention, a method of operating a solid oxide fuel cell having an anode and a cathode with dimethyl ether is provided. The method of this embodiment comprises forming a first mixture comprising air and dimethyl ether. The first mixture is then heated to a sufficient temperature to form a second mixture comprising carbon monoxide and molecular hydrogen. The second mixture is then contacting the anode of a solid oxide fuel cell with the second gaseous mixture. The second mixture is the fuel that powers the solid oxide fuel cell. Preferably, the solid oxide fuel cell includes an anode that comprises N₁—Y₂O₃ stabilized ZrO₂.

As set forth above, the method of this particularly preferred embodiment advantageously allows the fuel cell to be operated at a temperature that is less than about 650° C. Moreover, the first mixture is efficiently converted to the second mixture by heating at a temperature of at least about 450° C. More preferably, the first mixture is efficiently converted to the second mixture by heating at a temperature at least about 550° C. Most preferably, the first mixture is efficiently converted to the second mixture by heating at a temperature from about 550° C. to about 650° C. Moreover, in order to reduce the amount of water and carbon dioxide production the molar ratio of molecular oxygen to a dimethyl ether is from about 0.1 to about 3.0. More preferably, the molar ration of molecular oxygen to dimethyl is from about 0.1 to about 1.0.

In still another embodiment of the present invention, a fuel cell system using the methods of the invention is provided. The system of this embodiment comprises a source of a first mixture that comprises molecular oxygen and a compound having formula 1:
CH₃—O—R 1
wherein R is alkyl, aryl, alkaryl, or arakyl. The system further includes a heat source that heats the first mixture to a sufficient temperature to form a second mixture comprising carbon monoxide and molecular hydrogen. The system also includes a solid oxide fuel cell having an anode and a cathode. Finally, the system includes a conduit for transporting the second mixture and contacting the anode of the solid oxide fuel cell with the second gaseous mixture. The selection of the compounds having formula 1, the molar ratios, the sources of oxygen, and the temperature ranges are the same as set forth above.

In yet another embodiment of the present invention, a method for forming carbon monoxide and molecular hydrogen is provided. The method of this embodiment comprises forming a first mixture comprising molecular oxygen and a compound having formula 1:
CH₃—O—R 1
wherein R is alkyl, aryl, alkaryl, or arakyl. More preferably, R is a C₁₋₆ alkyl; and most preferably, R is methyl. The first mixture is then heated to a sufficient temperature to form a second mixture comprising carbon monoxide and molecular hydrogen. This method advantageously produces less than about 10 weight % water and less than about 10 weight % carbon dioxide of the total weight of the second mixture. The first mixture is efficiently converted to the second mixture by heating at a temperature of at least about 450° C. More preferably, the first mixture is efficiently converted to the second mixture by heating at a temperature of at least about 550° C. Most preferably, the first mixture is efficiently converted to the second mixture by heating at a temperature from about 550° C. to about 650° C. Although any source of molecular oxygen may be used including pure oxygen, the most economical and convenient source is air. Moreover, in order to reduce the amount of water and carbon dioxide production, the molar ratio of molecular oxygen to a compound having formula 1 is from about 0.1 to about 3.0. More preferably, the molar ratio of molecular oxygen to a compound having formula 1 is from about 0.1 to about 1.0.

The following examples illustrate the various embodiments of the present invention. Those skilled in the art will recognize many variations that are within the spirit of the present invention and scope of the claims.

### EXAMPLES

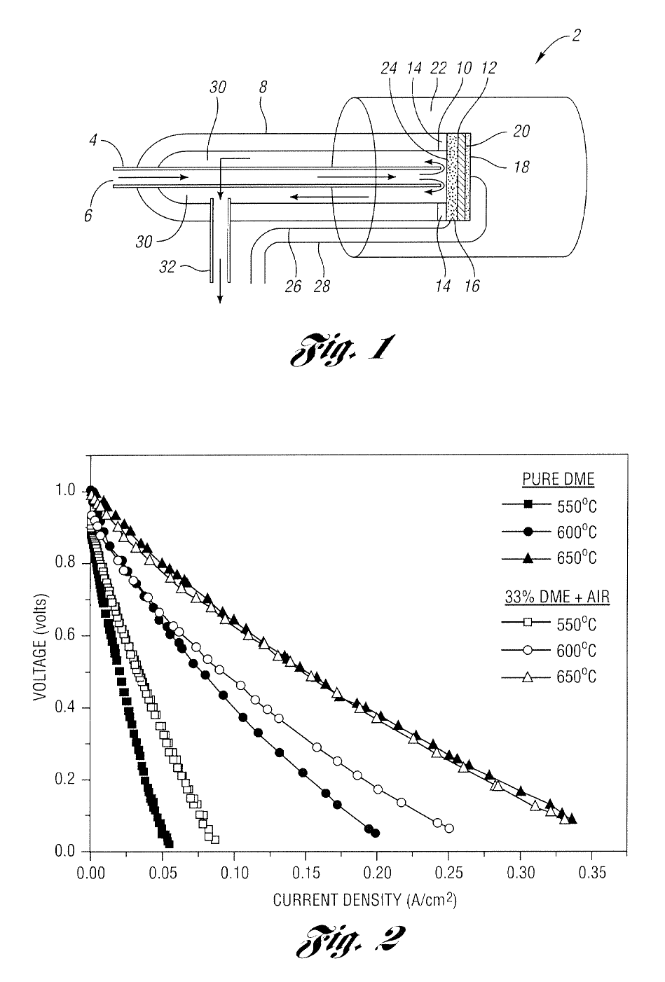

A solid oxide fuel cell was contacted with various gaseous mixtures that included dimethyl ether. The voltage-current output characteristics were measured for each of the mixtures. With reference to FIG. 1, a schematic of a SOFC apparatus that was used to introduce various mixture to a fuel cell is provided. SOFC apparatus 2 include an inlet tube 4 into which various gaseous mixtures are introduced through various tubing connected to position 6. Inlet tube 4 is at least partially contained within ceramic enclosure 8. End 10 of ceramic enclosure 8 is sealed to SOFC 12 with silver paste 14. SOFC 12 comprises anode 16 and cathode 18 which are separated by ion conducting layer 20. Gaseous mixture flows through inlet tube 4 as indicated by the arrows. While residing in inlet tube 4 the gases are heated by the action of furnace 22. The gaseous mixture then contact anode 16 at surface 24. The mixture then induces an electrochemical reaction in SOFC 12 which produces electricity. The electrical characteristics of SOFC 12 are measure via wires 26, 28. Remaining gases from the gaseous mixture or reaction bye-products are removed through chamber 30 which flow into outlet tube 32. Outlet tube 32 is attached to a mass spectrometer (not shown).

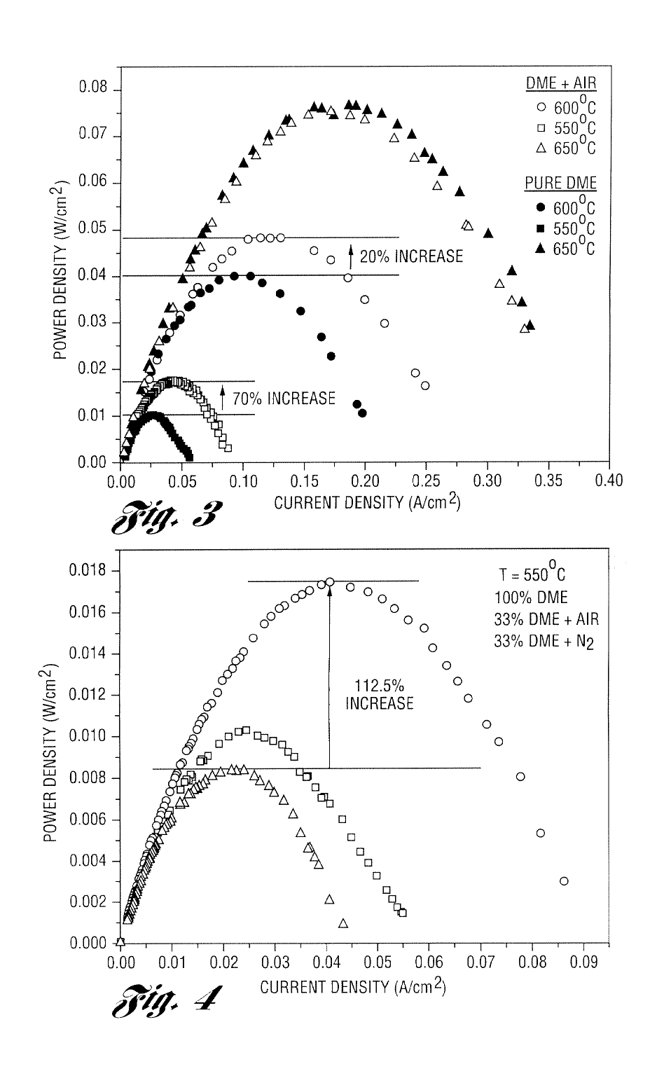

The results of experiments utilizing the apparatus of FIG. 1 are provided in FIGS. 2-4. With reference to FIG. 2, plots of voltage vs. current density for a SOFC fueled with a 100% DME gas composition and with a gaseous mixture of 33% DME in air are provided. FIG. 2 shows higher voltages produced for current densities at higher temperatures. With reference to FIG. 3, plots of power density vs. current density for pure DME and for a gaseous mixture of 33% DME in air are provided at 550° C., 600° C., and 650° C. At the highest temperatures the power density plots for the two gas compositions are nearly identical. However, an enhancement for the air containing compositions is observed at 550° C. and 600° C. This enhancement is completely unexpected. With reference to FIG. 4, plots of power density vs. current density for pure DME, for a gaseous mixture of 33% DME in air, and for a gaseous mixture of 33% DME in nitrogen are provided at 550° C. FIG. 4 shows that the power enhancement is due to the presence of oxygen and not nitrogen.

While the best mode for carrying out the invention has been described in detail, those familiar with the art to which this invention relates will recognize various alternative designs and embodiments for practicing the invention as defined by the following claims.

1. A method of operating a solid oxide fuel cell having an anode and a cathode, the method comprising:
forming a first mixture comprising molecular oxygen and a compound having formula 1:
CH₃—O—R 1
wherein R is alkyl, aryl, alkaryl, or arakyl;
heating the first mixture to a sufficient temperature to form a second mixture comprising carbon monoxide and molecular hydrogen; and
contacting the anode of a solid oxide fuel cell with the second gaseous mixture.

2. The method of claim 1 wherein the compound having formula 1 is dimethyl ether.

3. The method of claim 2 wherein the second mixture further comprises methane.

4. The method of claim 1 wherein the molar ratio in the first mixture of molecular oxygen to a compound having formula 1 is from about 0.1 to about 3.0.

5. The method of claim 1 wherein the molar ratio in the first mixture of molecular oxygen to a compound having formula 1 is from about 0.1 to about 1.0.

6. The method of claim 1 wherein the first mixture is heated to a temperature of less than about 650° C.

7. The method of claim 1 wherein the first mixture is heated to a temperature of at least about 450° C.

8. The method of claim 1 wherein the first mixture is heated to a temperature of at least about 550° C.

9. The method of claim 1 wherein the first mixture is heated to a temperature of from about 550° C. to about 650° C.

10. The method of claim 1 wherein the anode comprises a nickel-containing cermet.

11. The method of claim 1 wherein the anode comprises a component selected from the group consisting of nickel mixed with gadolina doped ceria, nickel mixed with yttria doped ceria zirconia, or nickel mixed with yttria doped zirconia.

12. The method of claim 1 wherein the first mixture is formed by combining air and the compound having formula 1.

13. The method of claim 1 wherein R is a C₁₋₆ alkyl.

14. A method of operating a solid oxide fuel cell having an anode and a cathode, the method comprising:
forming a first mixture comprising air and dimethyl ether;
heating the mixture to a sufficient temperature to form a second mixture comprising carbon monoxide, methane, and molecular hydrogen; and
contacting the anode of a solid oxide fuel cell with the second gaseous mixture.

15. The method of claim 14 wherein the molar ratio in the first mixture of molecular oxygen to a compound having formula 1 is from about 0.1 to about 3.0.

16. The method of claim 14 wherein the molar ratio in the first mixture of molecular oxygen to a compound having formula 1 is from about 0.1 to about 1.0.

17. The method of claim 14 wherein the first mixture is heated to a temperature of less than about 650° C.

18. The method of claim 14 wherein the first mixture is heated to a temperature of at least about 450° C.

19. The method of claim 14 wherein the first mixture is heated to a temperature of at least about 550° C.

20. The method of claim 14 wherein the first mixture is heated to a temperature of from about 550° C. to about 650° C.

21. The method of claim 20 wherein the anode comprises Ni—Y₂O₃ stabilized ZrO₂ and (Ce,Y)O2

22. A fuel cell system comprising:
a source of a first mixture comprising molecular oxygen and a compound having formula 1:
CH₃—O—R 1
wherein R is alkyl, aryl, alkaryl, or arakyl;
a heat source that heats the first mixture to a sufficient temperature to form a second mixture comprising carbon monoxide and molecular hydrogen;
a solid oxide fuel cell having an anode and a cathode; and
a conduit for contacting the anode of the solid oxide fuel cell with the second gaseous mixture.

23. The system of claim 22 wherein the compound having formula 1 is dimethyl ether.

24. The system of claim 22 wherein the molar ratio in the first mixture of molecular oxygen to a compound having formula 1 is from about 0.1 to about 3.0.

25. The system of claim 22 wherein the molar ratio in the first mixture of molecular oxygen to a compound having formula 1 is from about 0.1 to about 1.0.

26. The system of claim 22 wherein the second mixture further comprises methane.

27. The system of claim 22 wherein the heat source heats the first mixture to a temperature of less than about 650° C.

28. The system of claim 22 wherein the heat source heats the first mixture to a temperature of at least about 450° C.

29. The system of claim 22 wherein the heat source heats the first mixture to a temperature of at least about 550° C.

30. The system of claim 22 wherein the heat source heats the first mixture to a temperature of from about 550° C. to about 650° C.

31. The system of claim 22 wherein the anode comprises a nickel-containing cermet.

32. The system of claim 22 wherein the anode comprises a component selected from the group consisting of nickel mixed with gadolina doped ceria, nickel mixed with yttria doped ceria zirconia, or nickel mixed with yttria doped zirconia.)O2

33. A method for forming carbon monoxide and molecular hydrogen, the method comprising:
forming a first mixture comprising molecular oxygen and a compound having formula 1:
CH₃—O—R 1
wherein R is alkyl, aryl, alkaryl, or arakyl; and
heating the first mixture to a sufficient temperature to form a second mixture comprising carbon monoxide and molecular hydrogen.

34. The method of claim 33 wherein the step of heating the first mixture produces less than about 10 weight % water and less than about 10 weight % carbon dioxide of the total weight of the second mixture.

35. The method of claim 33 wherein the compound having formula 1 is dimethyl ether.

36. The method of claim 33 wherein the molar ratio in the first mixture of molecular oxygen to a compound having formula 1 is from about 0.1 to about 3.0.

37. The method of claim 33 wherein the molar ratio in the first mixture of molecular oxygen to a compound having formula 1 is from about 0.1 to about 1.0.

38. The method of claim 33 wherein the first mixture is heated to a temperature of less than about 650° C.

39. The method of claim 33 wherein the first mixture is heated to a temperature of at least about 450° C.

40. The method of claim 33 wherein the first mixture is heated to a temperature of at least about 550° C.

41. The method of claim 33 wherein the first mixture is heated to a temperature of from about 550° C. to about 650° C.

42. The method of claim 33 wherein the first mixture is formed by combining air and the compound having formula 1.

43. The method of claim 33 wherein R is a C₁₋₆ alkyl.
